(19) United States
(12) Patent Application Publication
(10) Pub. No.: US 2019/0110871 A1
(43) Pub. Date: Apr. 18, 2019

(54) BIONIC IMPLANTS AND MANUFACTURING METHODS THEREOF

(71) Applicant: AF PRAKTYKA STOMATOLOGICZNAFRYDRYCHEWICZ, Warszawa (PL)

(72) Inventor: Artur FRYDRYCHEWICZ, Warsaw (PL)

(21) Appl. No.: 16/097,246

(22) PCT Filed: Apr. 28, 2017
(86) PCT No.: PCT/PL2017/000045

§ 371 Date: Oct. 27, 2018

(30) Foreign Application Priority Data
Apr. 28, 2016 (PL) P.417028

(51) Int. Cl. A61C 8/00; A61C 13/08

(52) U.S. Cl. CPC A61C 8/0036; A61C 8/0043; A61C 13/08

(57) ABSTRACT

The present invention relates to a customized or standardized bionic implant and its manufacturing, especially for dental applications. According to the first variant of the invention, the implant is characterized in that its single-component anchor possesses at least two bionic arms (2) tapering circumferentially, thereby creating at least one pointed (5) and/or linear (6) blade on each arm (2). According to the second variant of the implant, the single-component anchor possesses at least two bulging arms (2) forming at least one protrusion (4) on each of them. The manufacturing method depends on whether the implant is standardized, new and customized or is a modification of an implant selected from a digital library of standardized implants. In all of these cases, the physical form of the anchor is printed in a 3D printer. In the case of customized implants, the process begins with obtaining tomographic images of the biological target. In the case of designing a new implant, a panoramic curve/curves and panoramic surface are set and become the basis for the arms (2) of the implant's virtual anchor.

The present invention relates to bionic implants and their manufacturing, especially for dental applications. Implants consist of a head, a core (corpus) and an anchor. The core is equipped with a prosthetic platform, which allows for the attachment of prosthetic or secondary components.

Traditional endosseous implants include the following: cylindrical and conical screw-type implants; threadless cylindrical implants; disc implants, needle implants and blade implants. The names assigned to these different groups of implants are derived from the shape of the anchor, i.e., the part of the implant that attaches to the bone. Their common feature is a simple geometric form usually designed to ensure ease of manufacture using traditional material processing methods (milling, threading, sheet metal cuffing). Implants can be single-component or multiple-component devices. The material traditionally used to manufacture implants is titanium, while the newest implants are made from zirconia or synthetic materials, e.g. PEKK—polyetherketoneketone. Most of these implants are inserted in the alveolar process by way of screwing the implant anchor into the bone.

The most popular implant anchors currently take the form of a cylindrical or conical screw. The latter tapers towards the bone facilitating the screwing in of the implant, e.g. KR200416306(Y1). To impede implant rotation around the longitudinal axis, various notches, indentations, and intersecting holes are used, as is for example shown in patent specifications CN101297772 (A), CN1565390(A).

The newest types of implants are bionic and biomimetic. For the needs of this description, bionic implants are defined as implants designed with inspiration from functions of objects present in nature. By way of contrast, biomimetic implants mimic the structures they replace. The best-known biomimetic implants imitate the shape of a tooth's roots (e.g. Replicate or Bioimplant). Most frequently, an anchor of this type differs from a pure replica of a tooth root in that its external surface possesses indentations or protrusions - these serve to increase the anchor's surface area, facilitate its embedding in the bone and create space for bone growth. Implants like these are only used in immediate implant placement procedures, and they are designed exclusively for making cemented restorations. Prior to the procedure, a structure approximate to that of the tooth root it is intended to replace is created based on analysis of tomographic imaging. Such anchors are manufactured by means of milling or CAD/CAM (Computer Aided Design/Computer Aided Manufacture) or SLM (Selective Laser Melting) methods.

The idea of bionic implants is to create a broad base for the implant so as to ensure greater stability and allow for many buttress points. With this aim in mind, attempts have been made to use needle implants whose anchors consist of separate needles, which, after being independently inserted into the bone, are then attached to the core by means of gluing or welding.

There are solutions where the implant resembles a tooth root but also possesses a regular geometrical shape, such as the implant shown in utility model CN203468769 (U). The anchor of this implant is shaped like a cylinder, which branches out into two arms with a uniform cross-section along their entire length.

A slightly different example of a bionic implant is that of the multi-root implant described in patent specification US2009061387 (A1). Emerging from the core are 2-4 separate, regularly shaped roots that taper towards the apex but have blunt ends. The number of the implant anchor's roots corresponds to the number of roots of the tooth that the implant is replacing. Subperiosteal implants (placed on top of the bone) that recreate the bone surface can also be called bionic implants. They were once made from a bone model prepared after taking impressions (a highly burdensome procedure) and using the lost-wax technique. They are currently made by use of tomographic imaging (3D) models, using CAD/CAM or SML methods.

A partially subperiosteal implant is shown in patent specification KR101469648 (B1). Here the implant has a titanium coating in the form of a mesh with openings for screws. The titanium mesh is placed on osseous tissue, thereby reproducing its shape, and soft tissue is placed on top of the titanium mesh.

The screws are screwed into the bone in order to ensure attachment of the titanium mesh, which also includes rings of a prosthetic platform.

If it is necessary to recreate the root system of a multi-rooted tooth whose roots branch outwards creating a wider base deep in the bone tissue, solutions involve the construction of anchors consisting of at least two parts that are attached during implant placement in order to avoid excessive drilling in the post-extraction socket.

In accordance with CN 100571651 C (WO2008125049 (A1)), holes are drilled in an anchor whose main part is screw-shaped, and during implant placement arms are placed in these holes at an acute angle to the axis of the main part of the anchor. The arms possess a regular cylindrical shape finished with a screw section. An implant anchor composed of two regularly shaped parts whose position corresponds to the branches of the tooth's roots is also shown in utility model CN201404302 (Y). A similar idea inspired the construction of the bionic implants described in patent applications US20130288201 (A1), U.S. Pat. No. 5,984,681 (A) and CN101249023 (A). A major drawback of the solution in which the anchor consists of two or more parts and is attached as a whole in situ, is that there is a risk of the formation of micro-gaps, through which bacteria can make their way to the bone, thereby causing inflammation around the implants (peri-implantitis).

Numerous modern radiographic techniques have contributed to advances in implantology, especially computed tomography, CT (currently the most recommended approach is cone beam computed tomography—CBCT, due to its reduced radiation dose)._In radiology, analysis of tomographic imaging utilises layers. It is possible to obtain an image of a layer of any section of the body, e.g. the head. In dentistry, CT scans are taken of the maxilla and the mandible. At present, the minimal layer thickness (slice) that can be achieved with advanced tomographic imaging device is 70 μm—the same as the voxel size used in such devices. The maximum thickness of a layer is the full scanning range (the summation layer). Traditional radiology distinguishes between three basic planes: frontal, sagittal and axial. These correspond to the position of the main tomographic layers—orthogonal (straight) layers—while the software currently used for analytical purposes also allows for layers that diverge from traditional planes by the angle desired by the user, producing oblique layers. It is also possible to produce a slice image comprised of consecutive short fragments of oblique layers at a tangent to the so-called panoramic curve. Panoramic curves are drawn arbitrarily with regard to objects of interest. This makes it possible to obtain a planar image of any given cross-section, known as the panoramic layer. The panoramic layer is used to create an image derived from computed tomography (CT), which is similar to a traditional pantomogram, also known as a panoramic image. Basing on the panoramic layer, cross-sections perpendicular to the panoramic layer are also obtained. This makes it possible to assess the availability of tissue essential for proper implant placement prior to performing the procedure, and ensures better preparation for planned procedures by allowing for the virtual superimposition of currently used implant models onto the image, i.a. This aids the selection of the right size of the implant.

Another modern implantological method is guided implant placement, which is currently employed by many manufacturers. This approach involves using tomographic imaging and 3D printing to create surgical templates. Its purpose is to achieve precise implant placement, which requires ensuring the implants position in the bone is set precisely with regard to both the surrounding tissue as well as future prosthetic restorations, using tomography analysis software. In order for implant placement to proceed according to plan, a 3D printed template should be prepared detailing how surgical instruments (for example, drills) and the implant/implants should be inserted.

The use of traditional implants is associated with many problems.

The biggest problem in implantology is that of bone deficit, for if a suitable margin of bone tissue is not preserved, primary stability cannot be achieved. The matter is further complicated by sensitive anatomical structures, such as nerves, passing through the bone. In the case of the mandible, the current state of the art offers two ways of solving this problem. The first method is bone augmentation, which involves “building” bone above the nerve canal. This is a complicated procedure that carries a risk of complications and a significant increase in costs due to the need for additional tools and materials. The second method is nerve lateralisation, which entails surgically cutting through the bone and repositioning the nerve. Once again, however, this is a risky procedure, which can lead to nerve damage, on top of which the scope of the procedure itself is very extensive. Both methods prolong the course of treatment due to the additional rehabilitation time required. In the case of the maxilla, implant placement requires augmentation procedures (a sinus lift, a bone graft from the iliac crest or other techniques of alveolar ridge reconstruction), which in turn have undesirable consequences. This often leads to situations where the patient is reluctant to undergo treatment. One compromise approach is to use threaded implants of small dimensions, which results in large unit loads on the contact surface between the implant and the bone. Bone remodelling as a result of increased loads leads to osseodensification and a decline in volume, which causes implants designed as endosseous implants to function as partially subperiosteal implants that remain only partially embedded in the bone. This is particularly disadvantageous in cases where the geometry of the implant creates sharp edges (for example, thread), which because they are not immersed in the bone cause harm to soft tissue, thereby damaging it and often causing inflammation, i.e. peri-implantitis.

This invention introduces a new approach to the construction and functioning of bionic implants.

In accordance with the present invention, a customised or standard bionic implant, especially for dental applications, containing at least one anchor and at least one rounded core, and which is equipped with a prosthetic platform, is characterised in that it features a single-component anchor that possesses at least two bionic arms tapering circumferentially (i.e. away from the core), thereby creating at least one pointed and/or linear blade on each arm. Preferably, there should at least be two anchor arms per root of the replaced tooth. Preferably, the anchor of the implant should possess one arm finished with a pointed blade acting as a central spike. In the preferred embodiment of the invention, at least one fragment of at least one of the arms tapers circumferentially on a cross section to form a linear blade that adjusts the trajectory of implant placement. Preferably, the arm of the implant anchor branches out into at least two arms.

In the preferred embodiment of the invention the axis of the implant core is a curved line.

Preferably, a fragment of the arm includes a protrusion to brace against the bone and/or provide support for the surrounding tissues, both hard and soft. In another solution, at least one entire arm is rounded in its cross-sections so as to brace against the bone. Preferably, the core possesses a concavity, which serves as a dome that can be filled with curable material, wherein the cross-sectional area of the dome opening is smaller than the cross-sectional area of its midsection.

In accordance with the present invention, another variant of the customised or standardised bionic implant, especially for dental applications, which contains an anchor and at least one rounded core equipped with a prosthetic platform, is characterised in that the single-component anchor possesses at least two bulging arms forming at least one protrusion on each of them, where there are at least two anchor arms per root of the replaced tooth.

In the preferred embodiment of the anchor structures mentioned above, at least two arms of at least one anchor interfuse to form an integrated volume.

The implants described above can be customised for a specific patient in the following way: using appropriate software allows for the use of 3D computer tomography data to obtain tomographic images of the biological target, virtually design the implant and print it out with a 3D printer, and subsequently subject it to mechanical and chemical processing. Proceeding with the first method in accordance with the invention, and equipped with a tomographic image of the biological target as well as with predicted shapes of prosthetic structure for which at least one implant is designed, the position of the prosthetic platform relative to the future prosthetic restoration, the size of the prosthetic platform and the direction of its axis are determined, followed by the position and shape of the axis of the implant core relative to the prosthetic platform and the biological target. Then, the shape of the core is determined, and the position and shape of the axes of implant anchor arms projecting from the point or points on the core axis are predetermined, where preferably the axes diverge. The axes of the anchor arms are identical to the panoramic curves on which the panoramic surfaces are formed. Next, using panoramic surfaces, the target shape and dimensions of the implant anchor's arms are determined, after which the implant is printed and undergoes finishing treatments. These treatments may include machining, milling, boring, threading, sandblasting, electro-polishing, anodising, etching as well as the depositing of bioactive materials.

The second method for manufacturing a customised implant differs from the first in that the implant is not so much designed but rather a predefined model is modified: after determining the position and size of the prosthetic platform relative to the future prosthetic restoration, a model of the implant that is predefined with respect to the shape of its core and anchor is chosen from a library of bionic implant shapes. The size of the implant is then determined and, if necessary, the selected implant model is optimised by modifying the direction of the prosthetic platform, the positioning of the axes of the core and the arms, after which the implant is printed and finalised.

In both methods used to manufacture a customised implant, final optimisation of the implant shape occurs after its structure is tested using the finite element method.

The manufacturing of a standard implant, the structure of which is defined above, entails the use of 3D design software to create a virtual implant that is printed in a 3D printer and then subjected to finalising processes. In the current state of the art, only customised implants are made with a 3D printer.

Bionic arms are, within the understanding of the present invention, arms modelled on biological forms, inspired by shapes and forms present in nature, such as claws, teeth (e.g. shark teeth), blades (claws of predators), fingers, thorns, catching elements (e.g. burrs), roots, mycelial chords, scales, and bulbs. The observation that nature adjusts form to function regardless of the scale is utilised here. Thus, when designing bionic implants in accordance with this invention, the aim was also to apply the rotational odd symmetry existing in the plant world in order to increase durability. Attention was also paid to the possibility of using biological development processes (morphogenesis) with the aim of seeking new forms. Digital morphogenesis enables transformations that adjust form and structure to the needs of utility. This, in turn, makes it possible to build complex, curvilinear spatial structures by increasing construction parameters.

The bionic anchor can serve as both an endosseous and a subperiosteal implant, due to the presence of these arms. Simultaneously, primary stability increases due to loading.

In accordance with the present invention, the implant anchor's arms possess a number of functions and associated advantages. These include increased anchor surface area; primary implant stability enhanced by the elimination of rotation; the establishment of an implant insertion trajectory by intruding into and binding in the bone; bracing against the bone; wedging that prevents deeper immersion, and buttressing the bone. The arms can either perform certain functions, or a single arm can perform several different functions, such as acting as a sharp end for intruding into the bone, or inhibiting further intrusion with a bulge on the proximal part of the implant.

For the needs of the present invention, panoramic surfaces are defined using the concepts of the panoramic curve and panoramic layer used in radiology. The simplest panoramic surfaces (identical to panoramic layers with hypothetical zero thickness) are obtained when parallel lines pass through panoramic curves, which slice the spatial image, and the surface of the intersection spreads out over a flat surface to produce a flat image of the intersected interior. A panoramic curve may consist of straight sections, with the panoramic surface then constituting a kind of multi-plane cross-section.

In contrast to panoramic layers, panoramic surfaces can be formed in a different and more complicated way. A panoramic surface can also be created on the basis of triangles joining two or more panoramic curves.

The basic criteria for determining panoramic curves and surfaces are: the exposition of bone volume available for placing the implant anchor's arms; the possible avoidance of sensitive structures and optimisation of the anchor's surface to ensure implant stability.

In accordance with the present invention, the anchor allows for more gradual anchoring in the bone as well as a gradual transition over time from functioning as an endosseous implant to functioning as a partially subperiosteal implant.

The arms are also used to model space for tissues around the implant. They also make it possible to adjust the geometry of the implant to the shape of any bone defect.

As was mentioned above, the arms of the implant anchor can provide space for bone reconstruction. The blades and spikes of the arms act as retention elements that ensure primary stability. They serve as an anti-rotational, supporting function and take on the main preliminary load during the healing stage.

This invention is especially suited for one-stage implants as well as for implants that feature an internal prosthetic platform in their core.

The implants in accordance with the invention perform well in cases of immediate implant placement as well as in delayed procedures, in extremely shallow and deep implant placement procedures, in both customised and standardised procedures. They open up new possibilities for developing surgical techniques. It is possible to piezosurgically prepare the implant bed using blades identical to the implant, to place implants by means of hammering (manual or aided with certain instruments, e.g. a magnetic mallet). There is a trend regarding the placement of increasingly shorter implants. The present invention enables implant placement in difficult anatomical conditions without the need for bone augmentation. By virtue of this invention, the axis of attachment of prosthetic restorations or secondary elements is independent of the axis of implant placement.

Implants in accordance with the invention can be manufactured using traditional methods or with the latest CAD-CAM or CAD-SLM software. All that is needed to manufacture the invention are zirconia, titanium, PEKK, and Ti alloys—materials that are widely used in implantology. Likewise, the surface can be finalised using well-known techniques.

The invention allows for lower costs and advances the availability of personalised solutions in medicine.

There are also other benefits involved with the use of this invention: there is no need for an expanded internal interface (connection); there are fewer faults; the elimination of areas of bacterial retention; and the possibility to achieve multidimensional stability (multi-point buttressing). This invention facilitates primary and secondary stability, and it reduces tension in the bone surrounding the implant, owing to a favourable distribution of forces.

Simultaneously, this invention does not determine the formal embodiments of the crown and core.

The object of the invention as presented in its embodiments will be explained using a schematic diagram, whereby:

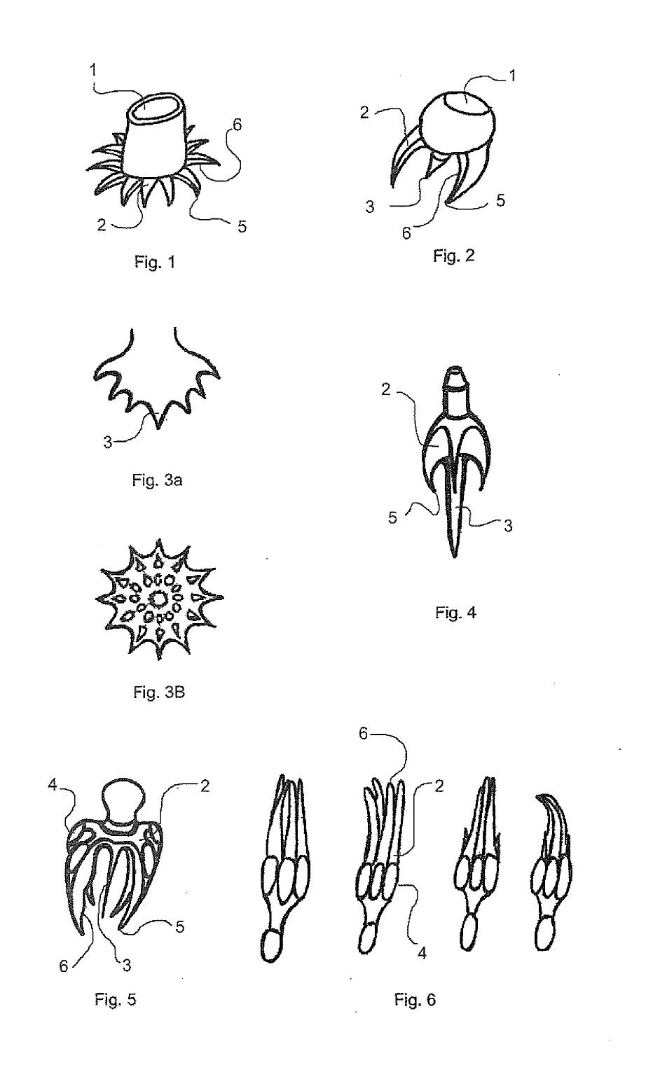

FIG. 1 shows the first embodiment of a standard implant;

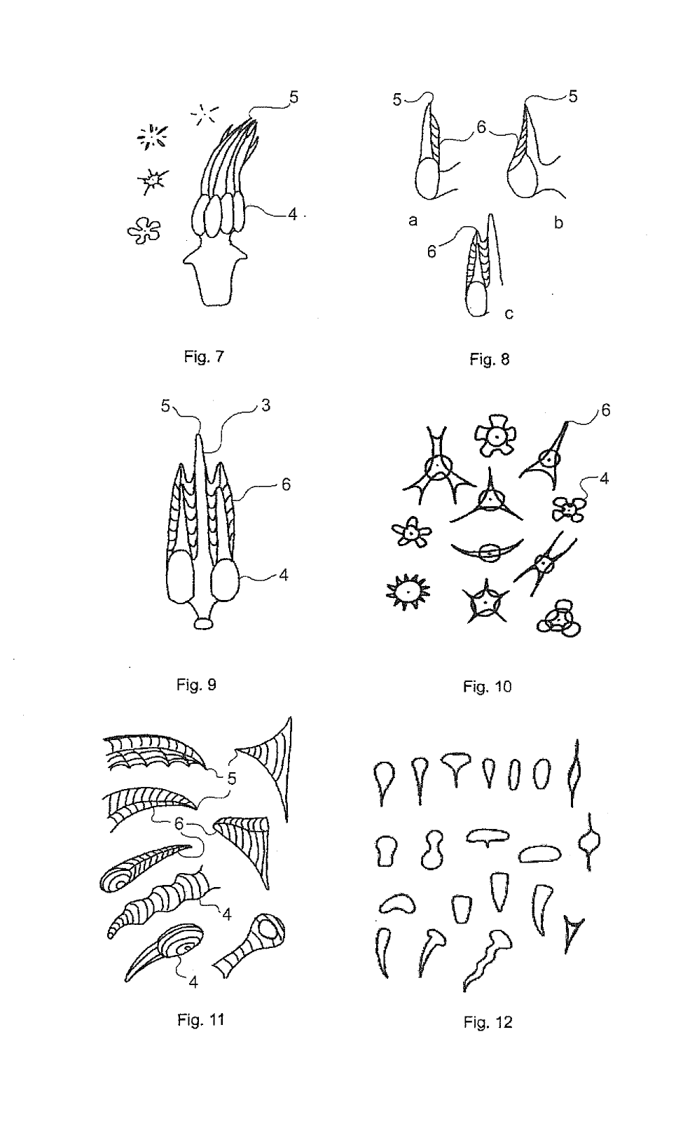

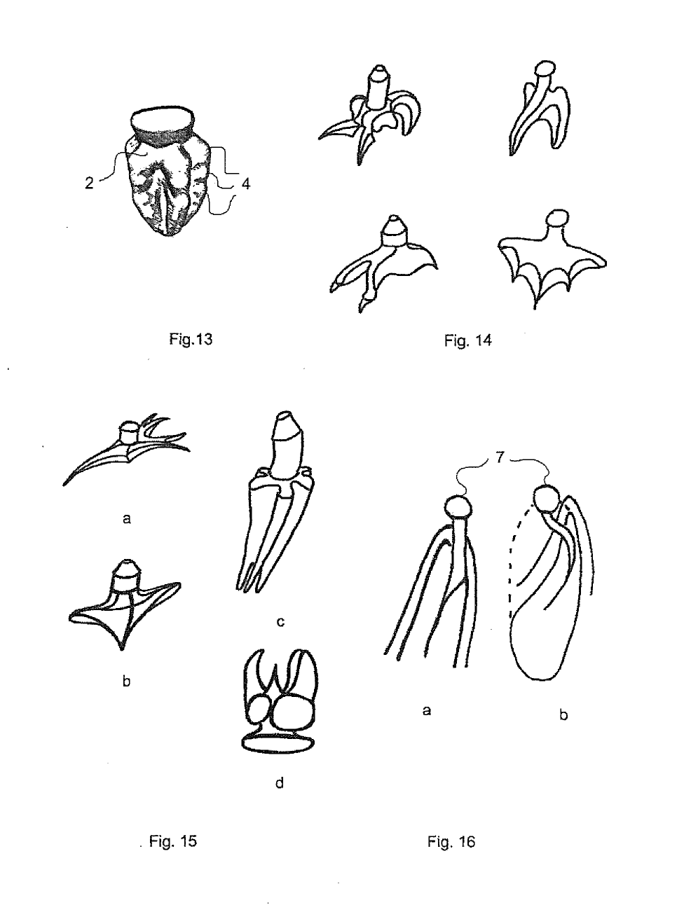

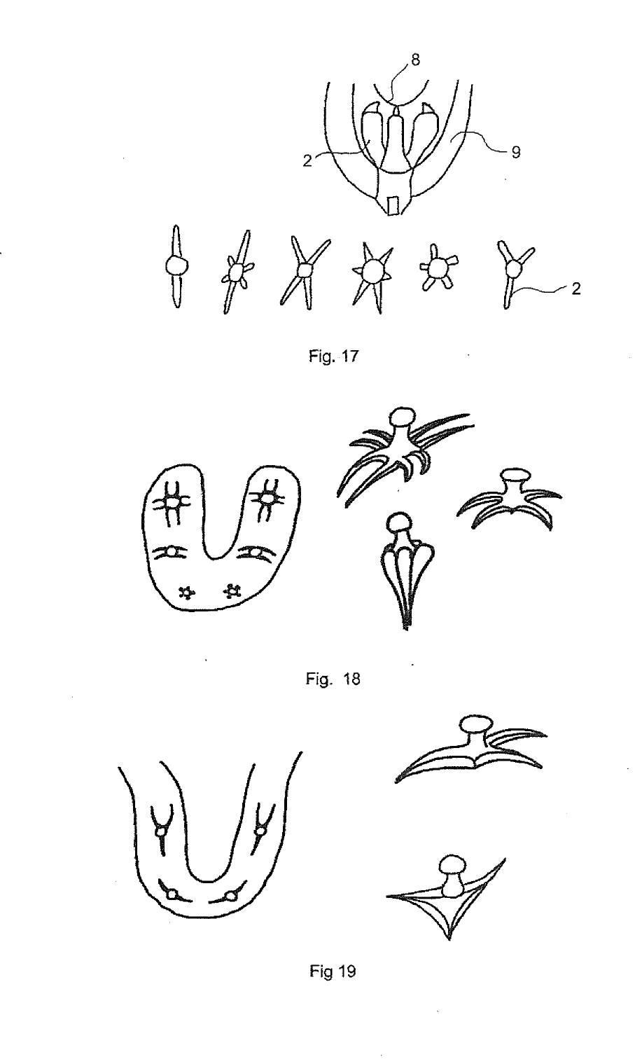

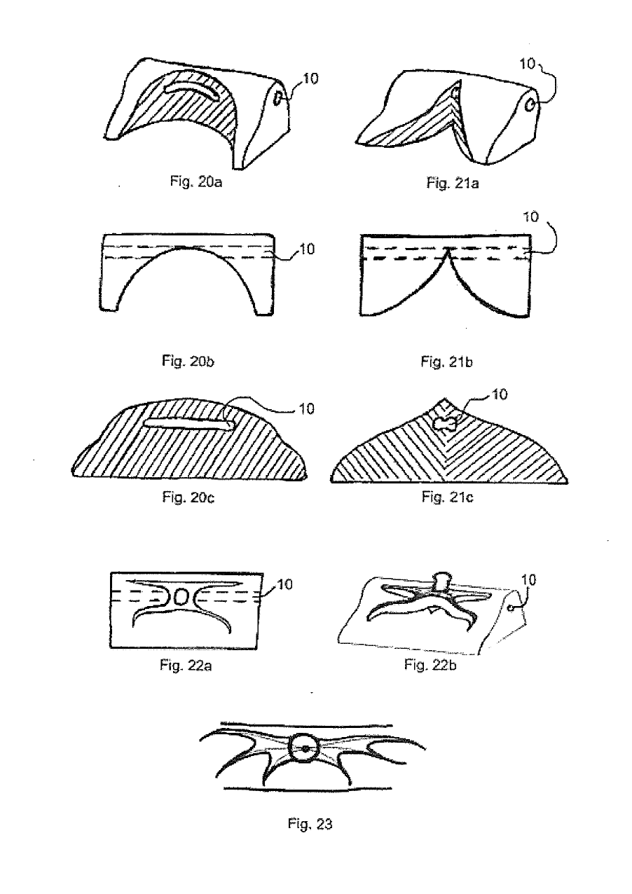

FIG. 2 shows the second embodiment of a standard implant;

FIG. 3a, 3b shows the third embodiment of a standard implant in its longitudinal section and view from below, respectively;

FIG. 4 shows the fourth embodiment of a standard implant;

FIG. 5 shows the fifth embodiment of both a standard implant and an individual implant;

FIG. 6 presents different versions of a variation of a standard or individual implant;

FIG. 7 shows an example of an implant with cross-sections of the anchor at different heights;

FIG. 8 shows a view of sample arms of an implant anchor;

FIG. 9 shows an implant that uses the arms from FIG. 8;

FIG. 10 shows sample views of cross-sections of implant anchors;

FIG. 11 shows examples of different individual arms of implant anchors;

FIG. 12 shows cross sections of sample arms;

FIG. 13 shows a sixth embodiment of a customised or standard implant.

FIG. 14, FIG. 15 show implants with different forms of anchors;

FIG. 16a, 16b shows cross-sectional examples of the alveolar process with a drawn implant outline;

FIG. 17 shows a cross-section of the alveolar process by the maxillary sinus with the implant as well as views of different embodiments of an implant anchor suitable for such a case;

FIGS. 18, 19 show a view of the maxilla and mandible, respectively, with examples of implants drawn in as well as the anchors of these implants.

FIG. 20.a shows a perspective view of a fragment of the mandible with a cut out panoramic surface, FIG. 20b presents the view from above of a fragment of the mandible from FIG. 20a, FIG. 20c shows the panoramic surface from 20a. on a plane;

FIG. 21a shows a perspective view of a fragment of the mandible with a cut-out of the panoramic surface, FIG. 21b shows the view from above of a fragment of the mandible with FIG. 21a, FIG. 21c shows the panoramic surface with FIG. 21a. on a plane;

FIG. 22a shows a view from above of a fragment of the mandible with a drawn implant anchor, while FIG. 22b shows a fragment of the mandible with implant anchor in perspective view.

FIG. 23 shows the view from above of a fragment of the mandible with implant anchor in another embodiment.

FIGS. 1-4 show examples of standard implants, which can be calibrated to create a range of implants ready for placement. In FIG. 1 the anchor is constructed out of a row of arms 2 in the shape of short claws finished with point blades 5 as well as linear blades 6. This kind of implant can be anchored at a very shallow depth, e.g., at 2 mm. Even this slight embedding of many short arms in the bone suffices, on account of the largest possible anchor surface achieved in such conditions and the relatively large area of the implant base, thus ensuring a high level of primary stability. In FIG. 1 as well as FIG. 2 the core of the implant possesses a dome-like concavity 1. This makes it possible to place different materials, such as elastomer and ferromagnetic materials, inside the implant.

FIG. 2 shows an implant with a standard structure and a greatly simplified geometry. It has a spherical core possessing a dome 1 and a central spike 3 as well as three sharp arms 2, which will pierce the bone like a thumbtack. In the case of this embodiment, implant placement ensures maximum simplicity. It is also suitable for temporary implant placement procedures, as the removal of such an implant would be simple, especially if fewer arms were used and the arms' surface is smooth.

Another example of a standard implant anchor similar to that shown in FIG. 1, in this case with a large number of small arms 2, is illustrated in FIGS. 3a and 3b. Presented in FIG. 3a is a longitudinal cross section of an implant anchor, while FIG. 3b offers a view from below. Visible in the anchor is a distinctive arm finished with a pointed blade in the form of a central spike 3, which bestows upon the anchor the main trajectory in which it enters into the bone.

The implants presented in FIGS. 1 and 2 are suitable for cases where the bone cannot be prepared too deeply, e.g. only at 2 mm. In the current state of the art, the problem has been to achieve stability, especially primary stability. Screw-type implants are not very well suited to cases where the insertion depth is less than 4 mm. In the current state of the art, screws with a large thread (disc) diameter are used, although they have a significantly smaller surface than that achieved by the anchor in accordance with the invention. In the same conditions, if we used the implant with the arms specified in the present invention we could achieve a much greater surface for the implant in the bone, which results in high primary and secondary stability parameters.

The anchor of the implant from Fig.4 possesses side arms 2 in the form of claws and a much longer spike 3 which makes it possible to set the original axis of placement. The arms 2 are tapered to form an arch. It is not necessary for all the side arms 2 to be embedded in the bone. A large amount of space is left around the implant anchor with this aim in mind so that the bone can grow into the space between the arms of the anchor, and at the edges of the side arms 2 we achieve support against the bone. During the healing stage the bone will also be able to grow above the anchor.

FIG. 5 shows the anchor of the implant intended for the alveolus following extraction of a lower molar. An implant of this kind is designed for immediate implant placement procedures. Located between the roots of the molar is the interradicular septum. The implant anchor has a central spike 3, which after extraction of the tooth sinks into the interradicular septum. The central spike 3 does not damage the septum in the same way as a screw-type implant (in the current state of the art), which requires drilling a hole with a much greater diameter than the diameter of the hole formed after inserting the central spike 3. Penetration of the interradicular septum ensures primary stability and determines the trajectory of the implant placement axis. The other arms 2 that enter the alveolus are significantly more branched than the original natural tooth or any kind of traditional implant used in such cases. These branched arms 2 increase the surface of bone apposition and the internal volume of the body of the implant into which the bone grows. The arms 2 also possess linear blades 6 directed towards the interior of the implant body. These blades also add primary stability by encroaching from the outside into the interradicular septum stretched by the central spike 3. The sharpened tips of the arms 2—pointed blades 5—are anchored at the base of the alveolus. In the lower core section the arms possess protrusions 4. These ensure that not too much pressure is placed on the bone in the zone where the bone is thinnest and the target loads are greatest. The complexity of the anchor surface in accordance with the specifications of the invention enables greater integration of the implant anchor with the bone than is the case with a traditional implant based on the current state of the art.

FIGS. 6, 7 and 9 show other examples of implant anchors that can be used in immediate implant placement. The anchor of the configured implant is to a certain extent modelled on the patient's own teeth, but differs from the original teeth in that it possesses arms 2, which form pointed blades 5 or linear blades 6 at the root apex, and protrusions 4 in the cervical section. Each of the side arms 2 can branch out into, e.g. two more arms whose blades can adjust the trajectory of implant placement. Moreover, if the anchor also has sides 2 with linear blades 6 at the edges, as in FIGS. 8 and 9, it can cut into the walls of the alveolus with these linear blades 6, thereby creating additional stability. On the other hand, in the region where healing conditions should be as stable as possible there are no blades, only smooth surfaces—protrusions 4, thereby resulting in reduced alveolar filling. During the course of remodelling, the bone tissue grows into the space between the arms 2 in the area of the largest secondary loads. In addition, in this area, the arms 2 remain immediately after implantation in gentle contact over a larger surface with bone tissue at the tops of the protrusions 4 spreading the alveolus below the bone itself, allowing tissue healing without compression while preserving their original outline. The elasticity of the bone ensures an even distribution of pressure along the circumference of the alveolus.

FIG. 8 shows examples of arms, which can be used in anchors of the type presented in FIG. 6, FIG. 7 and FIG. 9. Visible protrusions 4 pass through the thickened section of the arm, thereby ensuring rigidity of the structure, while further on is part of the arm, which features linear blade(s) 6. Protrusions 4 are responsible for taking the greatest secondary loads—here secondary stability will result from bone apposition. Linear blade 6 in the examples presented in FIG. 8 is located either inside the body of the implant (towards the interradicular septum of the alveolus—example 8a), or directed outside the body of the implant towards the alveolus—example 8b) or one arm features two blades pointed in opposite directions, connected with a linear blade running through the apex of the arm (example 8c). For example, 8c shows a situation where the greater part of the blade pointed towards the interior of the implant body connects with the core of the implant.

FIG. 9 shows an implant capable of replacing, for example, a two-rooted tooth or a single-rooted tooth with an elliptical cross-section of the root. The implant anchor possesses the arms from FIG. 8c. In this example, it is equipped with a central spike 3 situated on the axis of the implant core. Its role is to stabilise the implant path of insertion, giving the latter path a direction. In the example from

FIG. 9 the arms interpenetrate, forming in this way a common area—we can see the exterior contour. FIG. 10 presents views of cross-sections of implant anchors; these are cross-sections in relation to the axis of the implant core. The anchors of the implants are multi-armed. The cross-sections are at different heights and the side linear blades 6 are visible, as are protrusions 4.

FIG. 11 presents examples of different individual arms with a variety of complex shapes. The arm profile can be convex, concave or convex-concave.

The arms of the implant anchors in accordance with the present invention vary greatly, just as the needs are different on account of differences in the structure of maxillary and mandibular bones. The arms of implants ensure optimal use of bone volume by maintaining low unit pressure as well as integration with the bone tissue, thereby allowing for its stimulation with even loads. When the implant is inserted some linear blades 6 perform the role of fins the moment they come into contact with the bone—the movement of the whole implant will additionally be controlled and directed in accordance with the direction of these blades. These linear blades 6 can thus be used to control and correct the performance of the implant while it is being placed in the bone. The finite element method applied to these arms and to the anchor or implant as a whole ensure optimal configuration of the geometry of the arms and anchor from the viewpoint of structural analysis and bone tissue penetration dynamics.

FIG. 12 shows examples of cross-sectional shapes of particular arms, where some of these cross-sections may be cross-sections of the same arm at different heights. In other words, at one end an arm is sharp on one side and rounded on the other, and above it the blade becomes increasingly blunt until the end is rounded on both sides. The arms can assume many different shapes. FIG. 13 shows an implant configured in such a way that the rounded arms 2 are directed towards the base of the alveolus, and the blades of the arm converge, as if hiding in the core; the thicker parts of the arms—protrusions 4—provide support against the bone. This implant may be used either as a standard implant that can be calibrated, or as a customised implant adjusted through modifications of the shape of the arms to the shape of the tooth root following its extraction, i.e. the alveolus without the interradicular septum. Protrusions 4 distribute pressure on the bone evenly, but at the same time ensure primary stability through embedding, while the empty space between the arms provides space for the bone to grow into. This is one of the many possible configurations of the arms. This example differs fundamentally from implants available in the current state of the art, which are only superficially modified copies of an extracted tooth.

FIGS. 14 and 15 show many different forms of implant anchors in accordance with the present invention. The different shapes of anchors are suitable for different cases of implant treatment, depending on the shape of the alveolar processes and accessible depth of implant penetration. FIG. 15a shows the anchor of an implant suitable for shallow embedding, FIG. 15b shows an implant anchor suitable for cases involving a narrow alveolar process. Both examples are used with the osteodistraction technique (arms placed in the distraction gap). FIG. 15c shows an implant designed for immediate application as a replacement for a single-rooted tooth. FIG. 15d shows an implant intended for immediate application as a replacement for an upper molar.

The examples shown in FIGS. 16a and 16b are cross-sections of bone tissue with an implant in place that is similar to the implant shown in FIG. 15b and they illustrate the possibility of optimally placing an anchor in the margin of a narrow alveolar process as well as the flexible position of the prosthetic platform with respect to the alveolar crest, depending on the shape of the implant core. The dotted line in FIG. 16a illustrates the original contour of the bone tissue. The prosthetic platform is placed in the optimal position for prosthetic reconstruction.

Utilising the features of the present invention, the position of the prosthetic platform can be flexibly adjusted to the needs of the prosthetic restoration, while the anchor is maintained in the optimal position relative to the surrounding bone tissue. Prosthetic platform 7 is marked with a circle symbol. It allows for the most favourable distribution of forces in the bone—implant—prosthetic restoration complex. In accordance with the present invention, the anchor arms can be shaped in such a way as to maintain at all times an even margin of bone tissue around the anchor or an equal distance from the surface of the bone. The biggest loads are located close to the anchor's exit from the bone in the immediate vicinity of the points of force application. The anchors of the implant have blades directed in such a way that they denote the trajectory of bone penetration. If a blade is bent, the arm is inserted along the curvature of the blade. The implant bed can be prepared for the placement of the anchor with an instrument identical in shape to the anchor and possessing blades equipped with additional teeth - this instrument would be attached to a piezoelectric or sonic oscillation device used to prepare bone tissue. The implant bed will run through the external compact cortical layer of the bone, while further preparation will take place during implant placement, i.e. the anchor itself will be driven into the deeper layer of cortical bone with its blades, thereby making it possible to control the propagation of the distraction gap through gradual expansion. It is important that the forces ultimately acting on the bone through the implant be transferred via a smooth surface so that even if overloading and resulting bone loss occurs, no sharp edges create traumatic nodes either for the bone or the soft tissue covering it, as happens in the case of threaded implants.

FIG. 17 shows a cross-section of the alveolar process with a placed implant, where the base of the maxillary sinus 8 and soft tissue 9 are also marked. This example is applicable when there is little space in the maxilla deep in the alveolar process on account of the danger of penetration into the maxillary sinus 8. Also shown are examples of cross-sections of anchors with arms 2 intended for application in such cases. They make it possible to utilise the volume of bone in each direction through various configurations of the arms, which can be inserted into the bone by increasing the implant anchor surface.

One distinctive feature is that the implant core itself remains at a distance from the sinus base, which is not possible with traditional screw-type implants and requires either additional procedures or runs a risk of the implant penetrating the sinus. Even if such screw-type implants do not break through during placement, but are set at a shallow depth under the base of the sinus, they cannot be subjected to significant loading before osseointegration.

FIG. 18 shows an example of the distribution of different forms of implants in an edentulous maxilla as well as examples of possible forms that such implants can take. Similarly, FIG. 19 presents an example of the distribution of different forms of implants in an edentulous mandible as well as a view of such implants. The use of these forms together with their location allows us to optimise the distribution of forces under prosthetic restorations functioning as full dental arches.

FIGS. 20a and 21a show diagrams offering a perspective view of the tomographic image of a fragment of the mandible illustrating the course of the mandibular canal 9 (the course of the nerve and blood vessels), where certain fragments of these images have been cut out with different panoramic surfaces applied.

In the current state of the art, as was mentioned prior, layered cross-sections, which can be treated as panoramic surfaces if they have low thickness, are used for analysis of environmental conditions for implant placement. These cross-sections usually run along the length of the bone (and thus also the course of the mandibular canal), indicating insufficient space for traditional implants in cases of bone deficit.

FIGS. 20a and 20b show the construction of panoramic surfaces in two ways. In FIG. 20a the panoramic surface is a surface based on a semi-circular panoramic curve. FIG. 20.2 shows the view of such an intersection from above, while FIG. 20.3 illustrates the resulting panoramic surface achieved after its positioning on a plane. Such a panoramic surface creates an image similar to a traditional panoramic layer and would suggest that the nerve canal is a barrier almost impossible to avoid without performing additional procedures. In the search for a convenient panoramic projection of the arms of the anchor, this schematic fragment of the mandible was virtually intersected by a surface spread out on parallel lines drawn on a curve formed from two quarters of circles positioned as mirror images of each other, as is visible in FIG. 21a. In both cases, for simplicity's sake the panoramic curves are elements of simple geometric shapes. Just as in FIG. 20b, FIG. 21.b presents a view from above of a simplified fragment of the mandible with a panoramic curve and similarly to FIG. 20.c, FIG. 21.c shows the panoramic surface laid out on a plane obtained as a result of the above-described cut. In the example illustrated in FIGS. 21a, 21b and 21c the nerve canal is visible in a very small section at the site of the planned core. Only along a short section of the implant anchor does it extend above the bone, as a result forming a subperiosteal “bridge,” on which the core will be placed. A further part of the cross-section shows space free from hindrances within the bone tissue where the anchor arms can take shape freely.

And thus, in accordance with the present invention, in cases where, for example, the nerve canal is positioned in such a way that no room is left for the use of traditional implants, the panoramic surfaces can be arranged so as to construct an implant whose arms bypass the nerve and run parallel to it, even in quite close proximity, although essentially at a safe distance, thus ensuring a high level of implant stability.

In accordance with the method of present invention, panoramic surfaces are guided arbitrarily aiming to find the most convenient possible course for the anchor arms. Through the use of this procedure, we also have the possibility of dimensioning the available space to create an implant anchor with individual dimensions.

An anchor designed with the panoramic surface from FIGS. 21a, b and c is presented in FIGS. 22a and 22b. FIG. 22a shows the view from above of a fragment of a mandible with an implant anchor in place, while FIG. 22b presents a perspective view of a fragment of the mandible with the implant anchor in place. It can be seen that the core is located directly above the nerve canal, without, however, endangering it. The arms 2 of the anchor will run on both sides of the nerve canal 9, penetrating deeper in those places where the volume of bone is greater—just as the roots of a plant grow in soil while bypassing stones.

FIG. 23 presents in diagram form a projection of another sample implant on a plane perpendicular to the axis of the core against the background of the bone. Such an implant is suitable for cases of edentulism, even when there is extreme alveolar atrophy. The implant anchor possesses two arms that in turn branch out into three further arms, where the point on the axis of the core is the place where the panoramic curves intersect, as marked with dotted lines. The arms of the anchor are described on panoramic surfaces that begin on these panoramic curves.

Using the above described methodology as well as tools in the form of modern diagnostic imaging methods (e.g. computed tomography (CT) or magnetic resonance) together with 3D printing we are able to create functionally optimised implants owing to their bionic anchor arms.

1. A bionic implant comprising:
at least one rounded core having a prosthetic platform;
at least one anchor integrated with the core
the anchor having at least two circumferentially tapered bionic arms, each arm having at least one pointed and/or linear blade.

2-18. (canceled)

19. A bionic implant as claimed in claim 1, wherein the implant is a dental implant.

20. A bionic implant as claimed in claim 19, wherein the implant comprises at least two anchor arms per each root of the replaced tooth.

21. A bionic implant as claimed in claim 1, wherein the implant is customized to a specific patient.

22. A bionic implant as claimed in claim 1, wherein the at least two arms of the at least one anchor are interfused to form an integrated volume.

23. A bionic implant as claimed in claim 1 wherein at least one arm comprises a pointed blade which constitutes a central spike.

24. A bionic implant as claimed in claim 1, wherein at least one section of at least one of the arms tapers circumferentially so as to form a linear blade, for facilitating adjustment of implant placement trajectory.

25. A bionic implant as claimed in claim 1, wherein at least one of the arms is branched to at least two arm branches.

26. A bionic implant as claimed in claim 1, wherein the at least one core having a curved axis.

27. A bionic implant as claimed in claim 1, wherein at least one of the arms having at least one protrusion extending therefrom.

28. A bionic implant as claimed in claim 1, wherein at least one of the arms has rounded cross-section across its length.

29. A bionic implant as claimed in claim 1, wherein the core comprises a concave dome suitable for filling with curable material.

30. A method of making a customized implant having an integrated anchor comprising at least two bionic arms that taper circumferentially, thereby creating at least one pointed and/or linear blade on each arm, the method comprising the steps of:
a) utilizing 3D computer tomography data, obtaining tomographic image of a biological target for the implant placement;
b) virtually designing the implant by the steps of:
(i) determining the position of the prosthetic platform relative to a desired prosthetic restoration on the bases of the tomographic image of the biological target and the predicted shapes of the prosthetic structure, for which at least one implant is designed;
(ii) determining the size of the prosthetic platform and the direction of its axis;
(iii) determining the position and shape of the axis of the implant core relative to the prosthetic platform and the biological target;
(iv) determining the shape of the core;
(v) determining in advance the position and shape of the axes of implant anchor arms projecting from the point or points on the core axis, where the axes of the anchor arms are identical to the panoramic curves on which the panoramic surfaces are formed;
(vi) determining the final shape and dimensions of the implant anchor using at least one panoramic surface;
c) printing the implant out with a 3D printer.

31. The method according to claim 30, comprising, the step of utilizing finite element analysis to obtain a final optimization of the shape of the implant.

32. The method according to claim 30, further comprising the step of using finishing treatment operations on the implant.

33. The method according to claim 32 wherein the finishing treatment operations are selected from mechanical processing, chemical processing, and other surface conditioning.

34. A method of making a customized implant having an integrated anchor comprising at least two bionic arms that taper circumferentially, thereby creating at least one pointed and/or linear blade on each arm, the method comprising the steps of:
a. utilizing 3D computer tomography data obtaining tomographic image of a biological target for the implant placement;
b. modifying predefined virtual model from a library of bionic implants shapes by the steps of:
(i) determining the location and size of the prosthetic platform relative to a desired future prosthetic restoration;
(ii) selecting the implant model predefined with respect to the shape of the core and anchor of the implant from the library;
(iii) determining the size of the implant;
c. printing the implant out with a 3D printer.

35. The method according to claim 34, comprising the step of optimizing the selected implant model by modifying the direction of the prosthetic platform, the axis of the core and arms after.

36. The method according to claim 34, comprising the step of utilizing finite element analysis to obtain a final optimization of the shape of the implant.

37. The method according to claim 34, further comprising the step of using finishing treatment operations on the implant.

38. The method according to claim 37, wherein the finishing treatment operations are selected from mechanical processing, chemical processing.
